(19) United States
(12) Patent Application Publication
(10) Pub. No.: US 2015/0321923 A1
(43) Pub. Date: Nov. 12, 2015

(54) PIPE CONNECTOR FOR A WATER FILTER SYSTEM

(71) Applicant: Paragon Water Systems, Inc., Tampa, FL (US)

(72) Inventor: Shangfu Ma, Tampa, FL (US)

(73) Assignee: Paragon Water Systems, Inc., Tampa, FL (US)

(21) Appl. No.: 14/272,917

(22) Filed: May 8, 2014

(51) Int. Cl. C02F 1/00; F16L 9/19; E03C 1/042; B01D 35/02; E03C 1/04

(52) U.S. Cl. CPC C02F 1/003; B01D 35/02; E03C 1/0403; E03C 1/042; F16L 9/19; C02F 2307/06; C02F 2103/02

(57) ABSTRACT

A water filtration system is provided including a filter unit having a water inlet tube for receiving unfiltered water, and a water outlet tube for delivering filtered water. A pipe connector has an elongate body being connectable at one end to a faucet, and connectable at an opposite end to a water supply such that the connector delivers unfiltered water from the water supply to the filter unit via the water inlet tube, and the water is filtered and returned to the faucet via the water outlet tube. The elongate body includes a first port having a first cavity for delivering the unfiltered water to the filter unit, and a second port having a second cavity for receiving the filtered water from the filter unit. A divider wall is disposed inside the elongate body between the first and second ports for separating the filtered and unfiltered water.

### BACKGROUND

The present invention relates generally to pipe connectors, and more particularly to transition fittings for joining tubes and pipes of a water filtration system.

To improve odor, taste and/or remove contaminants from already potable drinking water provided to residential users, many people install supplemental water filtration systems. Conventional residential water treatment systems of this type are typically classified as whole house, under the counter mount, faucet mount and countertop mounted units. Conventional residential water filter systems typically include filter units that become filled with impurities over time and therefore need to be replaced periodically.

Most faucet mount and countertop filter systems allow users to switch between filtered water for drinking and unfiltered water for washing dishes and other household activities where filtered water is not needed. Often, countertop systems require a separate filtered water faucet that is separately plumbed from the main faucet adjacent. Thus, there is a significant amount of labor and material required in installing a countertop filter system. Thus, there is a need for a countertop or faucet water filter system that is relatively easily connected to existing plumbing.

### SUMMARY

The present disclosure is directed to a pipe transition fitting or connector configured for providing speedy and relatively easy connection of a filter unit of a water filtration system to existing plumbing. The present connector is designed to allow fast and reliable direct connection of the filter to the main incoming cold water line. As described in further detail below, the present connector allows a user to install the water filtration system without requiring a separate filtered water faucet. Instead, in the present system, all water passing though the main cold water faucet is filtered.

In the present connector, a divider wall is provided for separating filtered water and unfiltered water during operation. More specifically, an inlet opening of the present connector is dedicated for the filtered water only, and an outlet opening of the present connector is dedicated for the unfiltered water only, wherein the flows of the filtered and unfiltered water are separated by the divider wall for avoiding contamination.

More specifically, a water filtration system, including a filter unit having a water inlet tube configured for receiving unfiltered water, and a water outlet tube configured for delivering filtered water. A pipe connector has an elongate body being connectable at one end to a faucet, and connectable at an opposite end to a water supply such that the connector delivers unfiltered water from the water supply to the filter unit via the water inlet tube, and the water is filtered and returned to the faucet via the water outlet tube. The elongate body of the connector includes a first port having a first cavity configured for delivering the unfiltered water to the filter unit, and a second port having a second cavity configured for receiving the filtered water from the filter unit; and a divider wall is disposed inside the elongate body between the first and second ports for separating the filtered and unfiltered water.

In another embodiment, a pipe connector is provided for separating unfiltered water from filtered water to avoid contamination, and includes an elongate body connectable at one end to a faucet, and connectable at an opposite end to a water supply such that the connector delivers unfiltered water from the water supply to a filter unit via a water inlet tube, and the water is filtered and returned to the faucet via a water outlet tube. The elongate body of the connector includes a first port having a first cavity configured for delivering the unfiltered water to the filter unit, and a second port having a second cavity configured for receiving the filtered water from the filter unit. A divider wall in the connector is disposed inside the elongate body between the first and second ports for separating the filtered and unfiltered water.

### BRIEF DESCRIPTION OF THE DRAWINGS

FIG. 1 is a front elevation view of the present connector in a water filtration system;

FIG. 2 is a top perspective view of the connector of FIG. 1, featuring an inlet opening and an outlet opening of a water filter;

FIG. 3 is a plan view of the connector of FIG. 2; and

FIG. 4 is a vertical cross-section taken along the line 4-4 of FIG. 3 and in the direction generally indicated.

### DETAILED DESCRIPTION

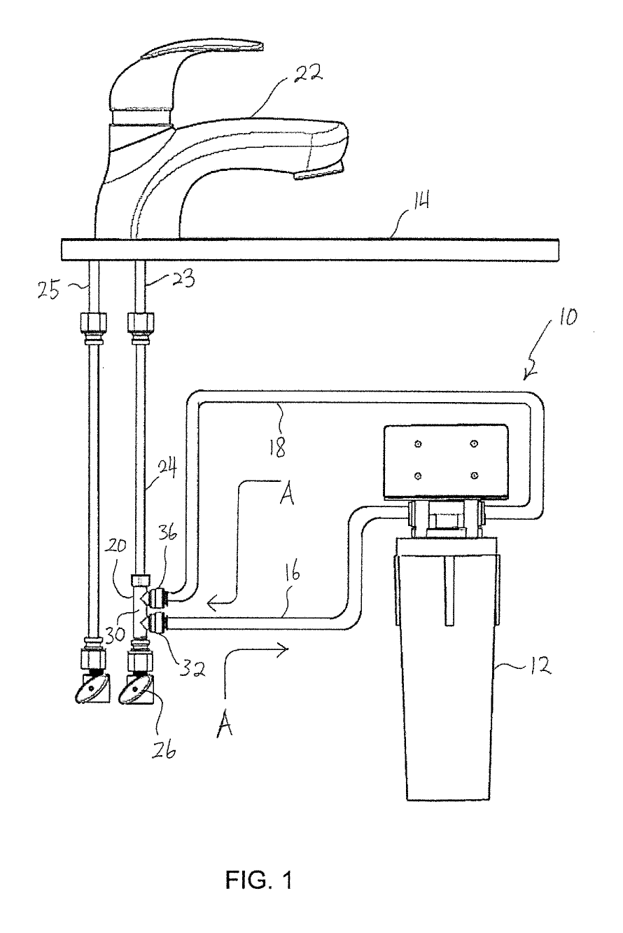

Referring now to FIG. 1, a water filtration system, generally designated 10, is used in homes and businesses to filter drinking water, with the water source being potable tap water. The water filtration system 10 typically includes a filter unit 12 placed under a countertop 14 or similar surface. Included in the filter unit 12 are a water inlet tube 16 configured for receiving unfiltered water, and a water outlet tube 18 configured for delivering filtered water. A pipe transition fitting or connector 20 is provided for connecting the filter unit 12 directly to a faucet 22 using a cold water supply line 23 and an optional hot water supply line 25. It is preferred that the present connector 20 is made with a thermoplastic polymer, such as polypropylene and/or other suitable materials known in the art.

The present connector 20 is connected at one end to the faucet 22 via a first pipe segment 24, and is connected at an opposite end to a cold water shutoff valve 26 via an optional second pipe segment (not shown) or directly to the shutoff valve without the second pipe segment. In operation, the present connector 20 delivers incoming or unfiltered water from the cold water valve 26 to the filtration system 10 via the water inlet tube 16, and the water is filtered and returned to the faucet 22 via the water outlet tube 18. An exemplary flow of the water is indicated by graphic arrows A.

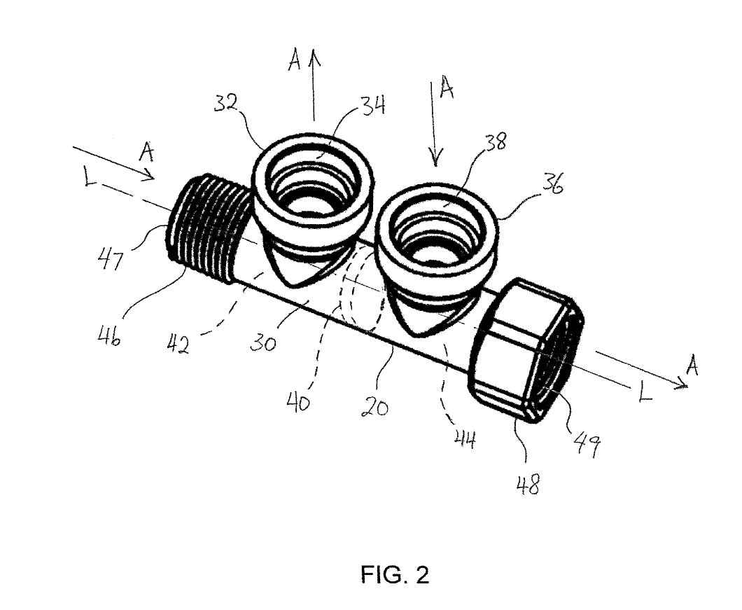

Referring now to FIGS. 1 and 2, the present connector 20 includes an elongate body 30 having a tubular shape, and further includes a first or outlet port 32 defining a first cavity 34 (FIG. 2) configured for delivering the unfiltered water to the filter unit 12, and a second or inlet port 36 defining a second cavity 38 (FIG. 2) configured for receiving the filtered water from the filter unit. Both outlet and inlet ports 32, 36 extend from an outer surface of the elongate body 30 transverse to a longitudinal axis L of the elongate body, and are arranged serially along the longitudinal axis adjacent to each other. It is contemplated that the functions (inlet/outlet) of the ports 32, 36 are interchangeable.

A divider wall 40 (FIG. 2, shown hidden) is provided inside the elongate body 30 of the present connector 20 between the outlet and inlet ports 32, 36 for separating the filtered and unfiltered water during use. It is contemplated that the connector 20 has a first or outlet chamber 42 (FIG. 2, shown hidden) defined by the divider wall 40 and an inner surface of the elongate body 30 in fluid communication with the outlet port 32 so that the unfiltered water can be delivered to the filter unit 12. Similarly, the connector 20 has a second or inlet chamber 44 (FIG. 2, shown hidden) defined by the divider wall 40 and the inner surface of the elongate body 30 in fluid communication with the inlet port 36 so that the filtered water can be delivered to the faucet 22.

As a result, the flows of the filtered and unfiltered water are separated by the divider wall 40 for avoiding contamination. Conventional push-in or quick-releasable fittings, such as John Guest® type fittings, are preferably used for the outlet and inlet ports 32, 36 for easy installation of the filter unit 12. Other suitable types of fittings are also contemplated as known in the art.

Also included in the present connector 20 are a first end 46 with an external male thread having a first opening 47 for receiving the unfiltered water, and an opposite second end 48 with an internal female thread having a second opening 49 for delivering the filtered water. The present connector 20 is attached to the first pipe segment 24 using complementary helically threaded portions of the first and second ends 46, 48 of the connector as is known in the art.

As illustrated in FIG. 1, the unfiltered water travels from the cold water valve 26 to the present connector 20, and then flows out of the outlet port 32 to be delivered to the filter unit 12 via the water inlet tube 16. After a purification process performed at the filter unit 12, the filtered water returns to the present connector 20 via the water outlet tube 18, and then flows into the inlet port 36 to be delivered to the faucet 22 via the first pipe segment 24. A feature of the present system 10 is that all of the incoming cold water is filtered, obviating the need for a separate filtered water faucet and associated connective plumbing.

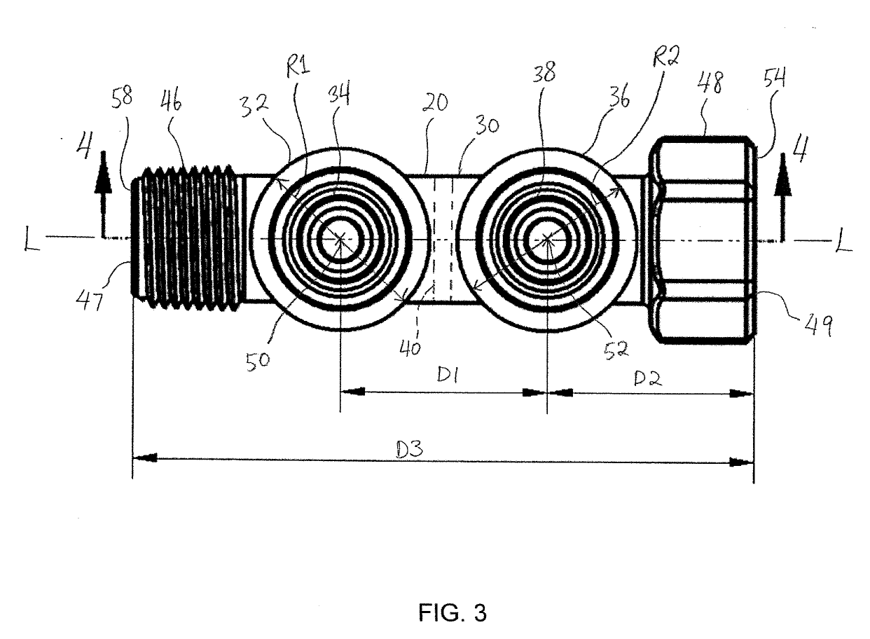

Referring now to FIG. 3, another important aspect of the present connector 20 is that a first or outlet center point 50 of the outlet port 32 and a second or inlet center point 52 of the inlet port 36 are spaced at a predetermined distance D1 relative to the longitudinal axis of the elongate body 30. An exemplary distance D1 is approximately 25.4±0.1 mm (or millimeters). Although the outlet and inlet ports 32, 36 are shown as separate units, the outlet and inlet ports are optionally constructed and arranged as a single unit having two cavities 34, 38 as long as the cavities are sufficiently spaced apart for accommodating attachment of the water inlet and outlet tubes 16, 18 (FIG. 1).

Further, the inlet center point 52 of the inlet port 36 is disposed from a female side face 54 of the second female end 48 at a predetermined distance D2. An overall longitudinal length D3 of the connector 20 is greater than a sum of the distances D1 and D2, and is about three times longer than the distance D1 or D2. An exemplary distance D2 is approximately 25.4 mm, and an exemplary distance D3 is approximately 76.26±0.3 mm. In a preferred embodiment, a first diameter R1 of the outlet port 32 is substantially the same as a second diameter R2 of the inlet port 36, and the first or second diameter has a dimension of about 30% of the longitudinal length D3. Other suitable distances D1-D3 and diameters R1-R2 are also contemplated to suit different applications.

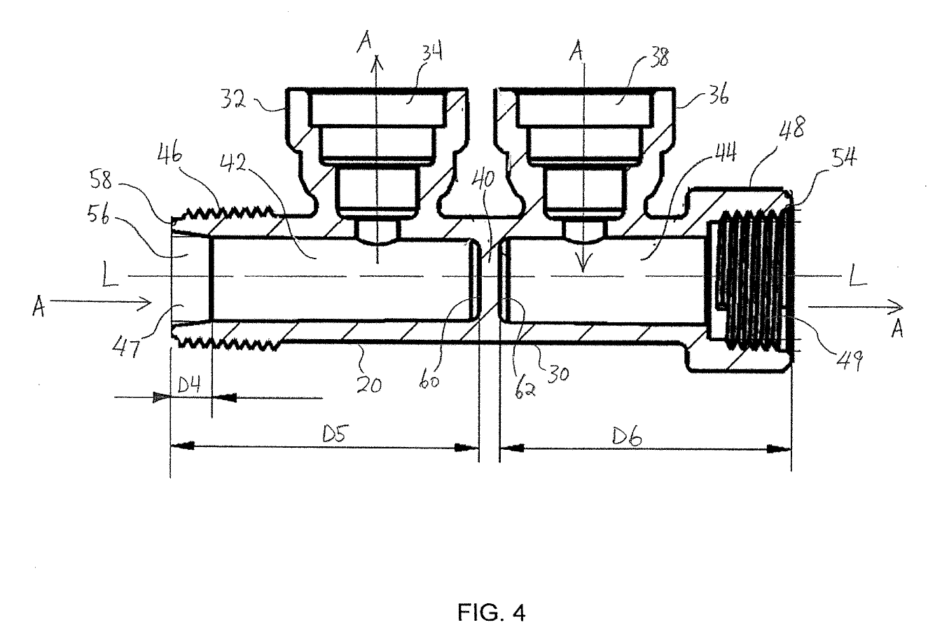

Referring now to FIG. 4, it is preferred that the first male end 46 has an outwardly flared or tapered inner wall 56 relative to the longitudinal axis L of the elongate body 30, and is configured for receiving the unfiltered water. The flared inner wall 56 has a predetermined width D4 relative to the longitudinal axis L. An exemplary width D4 is approximately 5.08 mm. It is also preferred that a male side face 58 and a first side wall 60 of the divider wall 40 is spaced at a predetermined distance D5, and the female side face 54 and a second side wall 62 of the divider wall 40 is spaced at a predetermined distance D6, wherein the distance D5 is longer than the distance D6. An exemplary distance D5 is approximately 37.91 mm, and an exemplary distance D6 is approximately 35.81 mm.

While a particular embodiment of the present pipe connector for a water filter system has been described herein, it will be appreciated by those skilled in the art that changes and modifications may be made thereto without departing from the invention in its broader aspects and as set forth in the following claims.

1. A water filtration system comprising:
a filter unit having a water inlet tube configured for receiving unfiltered water, and a water outlet tube configured for delivering filtered water;
a pipe connector having an elongate body being connectable at one end to a faucet, and connectable at an opposite end to a water supply such that the connector delivers unfiltered water from the water supply to the filter unit via the water inlet tube, and the water is filtered and returned to the faucet via the water outlet tube;
the elongate body of the connector including a first port having a first cavity configured for delivering the unfiltered water to the filter unit, and a second port having a second cavity configured for receiving the filtered water from the filter unit; and
a divider wall being disposed inside the elongate body between the first and second ports for separating the filtered and unfiltered water.

2. The water filtration system of claim 1, wherein the first and second ports extend from an outer surface of the elongate body transverse to a longitudinal axis of the elongate body, and are arranged serially along the longitudinal axis adjacent to each other.

3. The water filtration system of claim 1, wherein the connector has a first chamber defined by the divider wall and an inner surface of the elongate body in fluid communication with the first port so that the unfiltered water is delivered to the filter unit.

4. The water filtration system of claim 1, wherein the connector has a second chamber defined by the divider wall and an inner surface of the elongate body in fluid communication with the second port so that the filtered water is delivered to the faucet.

5. The water filtration system of claim 1, wherein at least one of the first and second ports uses a push-in or quick-releasable fitting.

6. The water filtration system of claim 1, wherein the connector includes a first end with an external male thread having a first opening for receiving the unfiltered water, and an opposite second end with an internal female thread having a second opening for delivering the filtered water.

7. A pipe connector for separating unfiltered water from filtered water to avoid contamination, comprising:
an elongate body being connectable at one end to a faucet, and connectable at an opposite end to a water supply such that the connector delivers unfiltered water from the water supply to a filter unit via a water inlet tube, and the water is filtered and returned to the faucet via a water outlet tube;
the elongate body of the connector including a first port having a first cavity configured for delivering the unfiltered water to the filter unit, and a second port having a second cavity configured for receiving the filtered water from the filter unit; and
a divider wall being disposed inside the elongate body between the first and second ports for separating the filtered and unfiltered water.

8. The pipe connector of claim 7, wherein the first and second ports are constructed and arranged as a single unit having the first and second cavities spaced apart sufficiently for accommodating attachment of the water inlet and outlet tubes.

9. The pipe connector of claim 7, wherein the connector includes a first end with an external male thread having a first opening for receiving the unfiltered water, and an opposite second end with an internal female thread having a second opening for delivering the filtered water.

10. The pipe connector of claim 9, wherein a first center point of the first port and a second center point of the second port are spaced at a first predetermined distance relative to a longitudinal axis of the elongate body.

11. The pipe connector of claim 10, wherein the second center point of the second port is disposed from a side face of the second end at a second predetermined distance.

12. The pipe connector of claim 10, wherein an overall longitudinal length of the connector is about three times longer than the first predetermined distance or the second predetermined distance.

13. The pipe connector of claim 12, wherein a first diameter of the first port is substantially the same as a second diameter of the second port, and at least one of the first and second diameters has a dimension of about 30% of the overall longitudinal length of the connector.

14. The pipe connector of claim 9, wherein the first end has an outwardly flared or tapered inner wall relative to a longitudinal axis of the elongate body, and is configured for receiving the unfiltered water.

15. The pipe connector of claim 9, wherein a side face of the first end and a first side wall of the divider wall is spaced at a third predetermined distance.

16. The pipe connector of claim 15, wherein a side face of the second end and a second side wall of the divider wall is spaced at a fourth predetermined distance, wherein the third predetermined distance is longer than the fourth predetermined distance.
